(19) United States
(12) Patent Application Publication
(10) Pub. No.: US 2011/0169363 A1
(43) Pub. Date: Jul. 14, 2011

(54) Variable Speed Electric Motor/Generator

(76) Inventors: Douglas Bruce Summers, Stouffville (CA); Thomas Arthur Clark, Whitby (CA); William Alexander MacMillan, Courtice (CA); S. Sreenivasa Murthy, New Dethi (IN)

(21) Appl. No.: 12/483,056

(22) Filed: Jun. 11, 2009

(51) Int. Cl. H02K 21/12

(52) U.S. Cl. 310/156.01

(57) ABSTRACT

The present invention is an electric energy converter for converting between mechanical and electric energy. The energy converter is operable at a high efficiency over a very wide rpm band. The energy converter includes a first peripheral magnetic field element (magnet) having a north pole and a second peripheral magnetic field element (magnet) having a south pole, the north pole of the first peripheral magnet being aligned with the south pole of the second peripheral magnet. The energy converter also includes a central magnetic field element (magnet) positioned between the first and second peripheral magnets, the central magnet having opposite north and south poles, the central magnet being oriented such that the north pole of the central magnet is aligned with the north pole of the first peripheral magnet and the south pole of the central magnet is aligned with the south pole of the second peripheral magnet. The energy converter also includes an armature comprising a plurality of parallel pairs of linear coils positioned between the peripheral magnets with the central magnet positioned between each pair of linear coils.

### FIELD OF THE INVENTION

The invention relates generally to electric motors and generators for converting between electric energy and mechanical energy by means of electromagnetic induction.

### BACKGROUND OF THE INVENTION

Electric generators are commonly used to convert mechanical energy to electricity using electromagnetic induction. They generally consist of a stator, a rotor, an armature and a magnetic field component. The magnetic field component generally consists of either one or more permanent magnets or one or more electro magnets. The armature consists of a series of windings which passes through the magnetic fields created by the magnetic field component. In most cases, the armature is built into the rotor and the magnetic field component is built into the stator. The generators are generally configured such that the windings are made to pass through the magnetic fields as the rotor spins. It will be appreciated that, as per the law of voltage induction in a conductor, the voltage induced in a conductor is governed by the formula e=Blv where e is the induced voltage, B is the flux density of the magnetic field through which the conductor is passing (in Tesla), l is the length of the conductor in meters and v is the speed of the conductor through the magnetic field in meters/sec. Therefore, the higher the rpm the generator experiences, the faster the windings pass through the magnetic fields and the greater the voltage induced in the winding (conductor). It will be appreciated that electric generators are not 100% efficient. Indeed, typically electric generators have efficiencies of about 80% or so, with 20% of the mechanical energy being wasted due to a variety of factors. One of the principle factors decreasing the efficiency of the generator is the rpm the generator is designed to operate at. Generally speaking, generators are quite efficient at high rpms. Standard four pole generators reach efficiencies of about 80% at rpms of about 18,000 while 6 pole generators reach similar efficiencies at 36,000 rpms. However, these generators become dramatically less efficient at lower rpms. Indeed, at rpms of 400 to 500 rpm, these generators are typically only about 20% efficient. At low rpms, these generators effectively extract very little energy. In typical generating applications this is not a problem since the motor or turbine coupled to these generators are operated to drive the generator at or near its optimal rpm band. However, in several applications it is not possible to drive an electric generator at a constant speed (rpm) at or near an optimal band. This is particularly the case in wind generator applications where, due to the fluctuations in wind speed, the generators coupled to the wind turbine will operate over an rpm range of less than 400 rpm to over 18,000 rpm. In fact, in a typical wind generation application, the generator will be operating significantly below its optimal rpm band a majority of the time.

Another disadvantage with present electric generators is their weight. Generally, the armatures of typical electric generators consist of ferromagnetic cores with copper windings thereon. While effective, they are none the less very heavy due to the amount of iron required to make up the cores and the amount of copper required for the windings. The electric generator using such an armature is necessarily quite heavy, making its use in wind generation applications more cumbersome because the generator has to mounted on top of a tall tower.

An improved electric energy converter which is light and which is efficient in converting mechanical energy into electric energy over a wide rpm band would be particularly useful in wind generation applications. Such an energy converter would also be useful in a combination motor/generator for use in electric vehicle applications.

### SUMMARY OF THE INVENTION

In accordance with one aspect of the present invention, there is provided an electric energy converter for converting between mechanical and electric energy. The energy converter is operable at a high efficiency over a very wide rpm band. The energy converter includes a first peripheral magnetic field element (magnet) having a north pole and a second peripheral magnetic field element (magnet) having a south pole, the north pole of the first peripheral magnet being aligned with the south pole of the second peripheral magnet. The energy converter also includes a central magnetic field element (magnet) positioned between the first and second peripheral magnets, the central magnet having opposite north and south poles, the central magnet being oriented such that the north pole of the central magnet is aligned with the north pole of the first peripheral magnet and the south pole of the central magnet is aligned with the south pole of the second peripheral magnet. The energy converter also includes an armature comprising a plurality of parallel pairs of linear coils positioned between the peripheral magnets with the central magnet positioned between each pair of linear coils.

In accordance with another aspect of the present invention, there is provided an electro-mechanical energy converter functional as either an electric motor or as an electric generator. The electromechanical energy converter is both light weight and is operable at high efficiency over a wide rpm band. The electromechanical energy converter includes a housing for containing a rotor and a stator. The stator includes a central magnet positioned between first and second peripheral magnets, the central magnet having an axis and opposite north and south polls on opposite sides of the axis. The first and second peripheral magnets each have north and south polls. The central magnet and the first and second peripheral magnets are oriented such that the north poll of the central magnet is oriented towards and aligned with the north poll of the first peripheral magnet and the south poll of the central magnet is oriented towards and aligned with the south poll of the second peripheral magnet. The rotor is rotatably mounted to the housing and includes at least one pair of parallel windings oriented such that the windings are positioned between the first and second peripheral magnets and the central magnet is positioned between the windings. The windings are oriented such that they remain parallel to the axis of the central magnet when the rotor is spun.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1. is a long sectional view of an energy converter made in accordance with the present invention.

FIG. 2 is a cross sectional view of an energy converter made in accordance with the present invention.

FIG. 3 is a graphical representation of the power output of two energy converters made in accordance with the present invention as a function of rpm and one energy converter not made in accordance with the present invention.

FIG. 4 is a table showing the effective efficiency of an energy converter made in accordance with the present invention at a variety of rpms.

In the drawings like characters of reference indicate corresponding parts in the different figures.

### DETAILED DESCRIPTION OF THE INVENTION

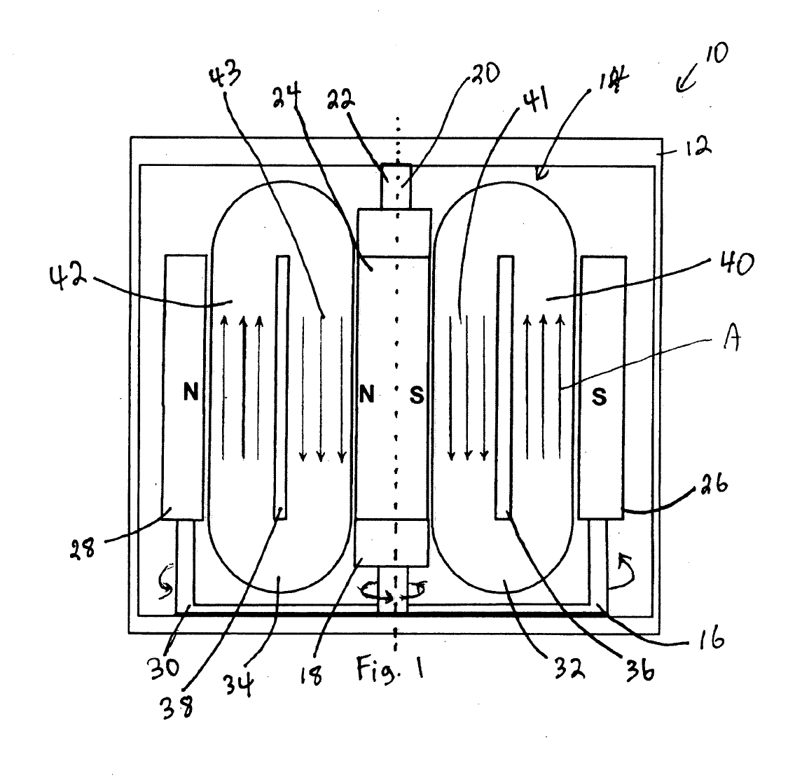

Referring firstly to FIG. 1, an energy converter made in accordance with the present invention is shown generally as item 10 and consists of a housing 12 within which is mounted a stator 14 and a rotor 16. Rotor 16 consists of a central magnetic field element (magnet) 18 and first and second peripheral magnetic field elements (magnets) 26 and 28, respectively. Central magnetic field element 18 has central axis 20, shaft 22 and magnet body 24. Magnet body 24 has opposite N and S poles, as illustrated, positioned on opposite sides of central axis 20. Magnetic field elements 26 and 28 have N and S poles, respectively. The magnetic field elements are oriented relative to one another such that S pole of magnetic field element 18 is oriented towards and aligned with S pole of magnetic field element 26 while the N pole of magnetic field element 18 is oriented towards and aligned with N pole of magnetic field element 28. Central magnetic field element 18 preferably consists of an elongated and cylindrical permanent magnet forming magnet body 24. Preferably, magnet body 24 is made of a strong magnet alloy such as NbFeB. Magnet body 24 is configured with the N pole on one side and the S pole on the opposite side. Cylindrical permanent magnets suitable for use in this invention are commercially available.

Magnets 26 and 28 are preferably elongated permanent magnets also made from a strongly magnetic alloy such as NbFeB. The magnets are oriented such that the S pole of magnet 26 is oriented towards the S pole of magnet body 24 while the N pole of magnet 28 is oriented towards the N pole of magnet body 24. Magnets 28, 24 and 26 are coupled by rotor housing 30 which ensure that the three magnetic field elements rotate together in unison around stator 14.

Stator 14 consists of a pair of flat linear coils 32 and 34 which are positioned between magnets 26 and 28 with central magnet body 24 positioned between the pair of flat linear coils. Preferably, coils 32 and 34 are elongated with elongated sections 40 and 42 extending parallel to central axis 20 of central magnetic field element 18. Coils 32 and 34 and have elongated central portions 36 and 38, respectively. Coils 32 and 34 and magnets 24, 26 and 28 are configured and positioned relative to one another such that the magnetic flux between the magnets cuts opposite sides of the same coil. This maximizes the induced voltage in the coils as the current flows in the direction shown by arrows A. This is accomplished by balancing the magnetic strengths of magnets 24, 26 and 28 and the position of coils 32 and 34 so that areas of minimal magnetic flux extend along central portions 36 and 38 when the coils are positioned between the magnets. Essentially, each side of each coil cuts the magnetic flux of the magnet closest to it. Hence, side 40 of coil 32 cuts the magnetic flux of the S pole of magnet 26 while side 41 of coil 32 cuts the magnetic flux of the S pole of magnet 24. Likewise, side 43 of coil 34 cuts the magnetic flux from the N pole of magnet 24 while opposite side 42 of the same coil cuts the magnetic flux from the N pole of magnet 28. Since coils 32 and 34 are relatively elongated, sides 40 and 41 are relatively straight and parallel and will have a relatively linear motion ν with respect to rotating magnets 24, 26 and 28. As magnets 24 and 26 pass coil 32, voltage e1 is induced on side 40 and voltage e2 is induced in side 41. While voltages e1 and e2 may be of different values due to the relative speed of the coil, both voltages e1 and e2 are summed in the coil. The same, but mirror, effect occurs in coil 34 as it is passed by magnets 28 and 24. This greatly increases the efficiency of the device since voltage is being induced in both sides of each coil simultaneously.

Each of the coils have several turns, based on the design requirements, namely the available flux density, desired voltage and operating speed. Effectively, there are two air gaps, one between the interior magnet and coil and the other between the exterior (peripheral) magnet and the coil. Both air gaps are in a radial direction. Rotor housing 30 ensures that the interior magnet rotates in unison with the peripheral magnets. Both coils 32 and 34 are connected in series (although a parallel arrangement is also possible) to form one phase.

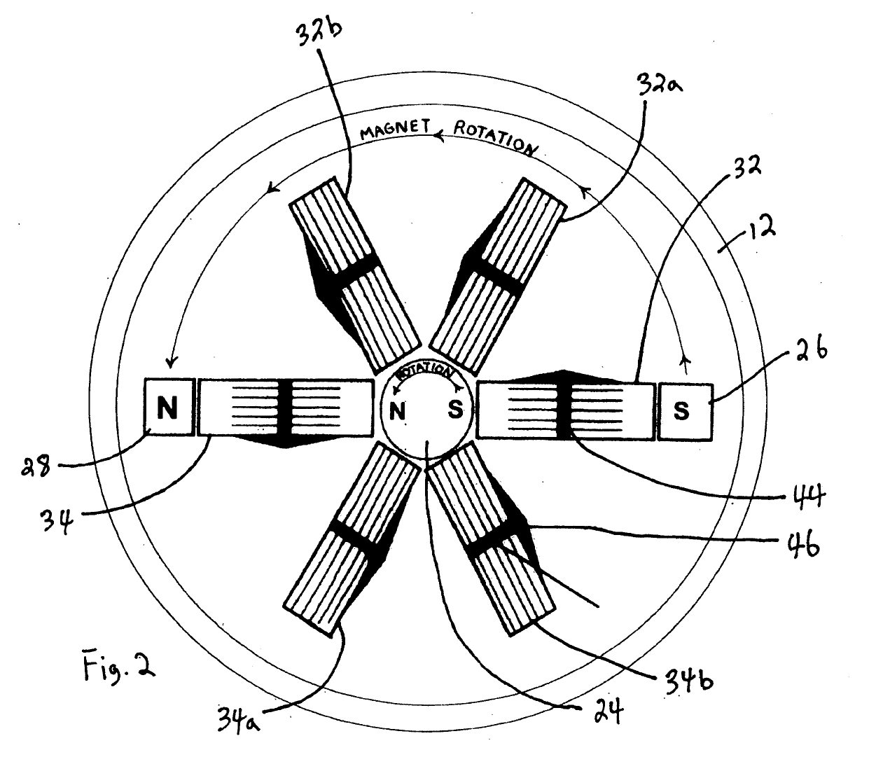

Referring now to FIG. 2, another two pairs of coils, 32a/34a and 32b/34b can be added to form a 3 phase energy converter as illustrated. As mentioned previously, side 41 of coil 32 and side 43 of coil 34 cuts the magnetic field lines of magnet 24 while side 40 of coil 32 cuts the magnetic field lines of magnet 26 and side 42 cuts the magnetic field lines of magnet 28. To better isolate each half of the coils, an iron core 44 may be added at the point of minimal magnetic flux between the magnets. The iron cores may form a ring which passes through all of the coils. Alternatively, iron cores 44 may have a cap portion 46. The iron core increases the magnetic isolation between the portion of the coil adjacent the innermost magnet and the portion of the coil adjacent the outermost magnet. It is also possible to place suitable strong rotating magnets on top and below the coils.

The present invention has many advantages over the prior art. Firstly, this coil arrangement facilitates voltage induction in both sides of the coil by distinct magnets placed in their vicinity at a given instant. The dual air-gap facilitates such augmented voltage induction.

In a linearl coild design, the geometry is such that the larger the wire and/or number of turns of the coil further the distance the flux source becomes, making the design somewhat inefficient. However, in the present invention, with linear design coils using Repelling Magnetic Fields (RMF), the two identical forces (N-N or S-S) induce both halves of the coil windings simultaneously. The magnetic fields do not cross the two repelling forces and create a Magnetic Neutral Zone (MNZ) that meet and rests inside the core of the coil. Iron in the core acts as a shielding property so that the MNZ remains neutral and the opposing fields do not intrude on the canceling side of coil. Also the addition of iron to the core only is to capture and direct the magnetic filed lines in a liner direction. If iron is not used in a rotating field the magnetic flux lines take the path of least resistance and tend to curve and bend around the conductor (coil) and thus not fully penetrate the depths of the windings.

Another advantage of the linear design is the long lengths of ninety degree wire to the flux source (working wire WW). The linear design enables a much greater percentage of this WW compared to traditional electric generators or motors. Also there is no limits on the length of a linear coil as long as you add the appropriate flux source additions, in fact the more linear the design the smaller percentage of wasted wire or wire that is not ninety degree to the flux source. End winding or inactive part of the coil can be considerably reduced.

Heat dissipation is a problem with traditional designs as the wire builds up heat due to current and the heat must travel thru the depths of the windings and does not dissipate effectively. In the present invention the sections of coil have an extremely large surface side area in which heat can dissipate rapidly along with the air flow caused by the moving carousel.

The linear coil design also avoids the drawbacks of traditional toroidal windings. The traditional toroid is wound by loading the wire onto a winding shuttle, and then winding the wire around the coil as it is removed from the shuttle. The build of the coil is different in three places on the toroid. The build is determined on the Outside Diameter (OD) and Inside Diameter (ID) by the relationship between the wire OD and the diameter of the coil. The toroid form and winding method makes it hard to control the wire on the ID during winding. The number of turns per winding layer are reduced by at least six with each subsequent layer. This prevents the wires from nesting in the valleys of the previous layer. Thus, the wire on the ID of a toroid is not perpendicular to the magnetic field of the generator. This also results in a fair amount of unused area of the core. The final difficulty toroidal winding has is that it is next to impossible to wind the core to a specific ID. In the present invention, the windings ensure that all wires are perpendicular to the magnetic flux. The turns each coil are the same and the ID of the coil is held to a specific tolerance. The winding also allows nesting of the magnet wire during winding. This fact, gives this design more turns than a typical toroid design.

Another advantage of the present invention is the ability to wire it for multi-phase operation. Single phase, two phase, three phase, four phase, six phase and twelve phase wiring are all an option with this design. Six-phase operation will give the most cost effective operation since no filter capacitor is necessary and the three phase rectifiers are simple to wire. This allows much greater efficiency since three coils are contributing to the output power at any instant in time.

The winding scheme of the present invention also allows cooling of ht coils due to the radial design of the coil segments. The traditional toroid requires that heat generated in the windings flow through the entire winding to the ID or OD to be dissipated by airflow past the coil. Airflow between segments will cool the coils form both sides and ends. This is a much shorter path and since the wires are nested, it has less thermal resistance. The coils will run cooler and this will reduce the power loss as I² R losses will be less.

This design of construction has, with proper choice of core material, the ability to hold a very tight core ID. The windings can be wound and assembled on a straight core and the core and winding assembly can be formed around a jig to gibe the desired ID. This is a significant advantage in generators since the flux varies with the square of the distance from the flux source.

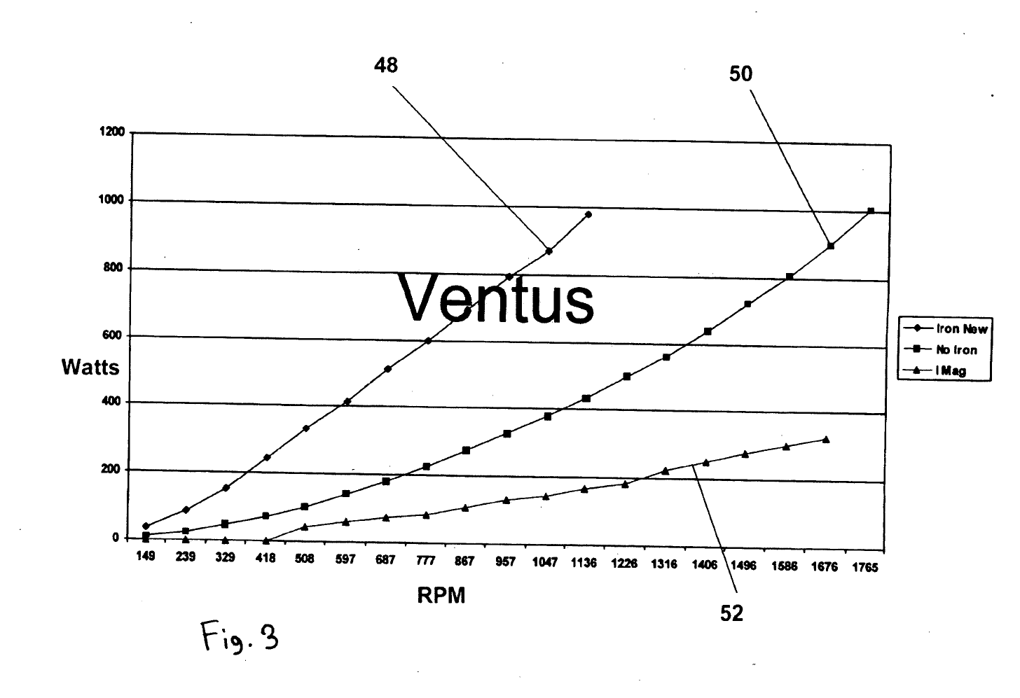

The net effect of these advantages is to produce an energy converter which is capable of converting electricity to mechanical motion (or the reverse) in a wide RPM band. FIG. 3 illustrates how a generator made in accordance with the present invention can generate significant quantities of energy even at very low rpms. FIG. 3 plots the power (in watts) generated by two generators made in accordance with the present invention, as a function of generator rpm. Line 48 plots the power output vs. rpm for a generator made in accordance with the present invention which incorporates iron cores (as shown in FIG. 2). Line 50 plots the power output vs. rpm for a generator made in accordance with the present invention which does not incorporate iron cores. Line 52 plots the power output vs. rpm for a generator made the traditional way (i.e. not in accordance with the present invention). As can be seen in FIG. 3, generators made in accordance with the present invention are capable of generating power even at very low rpms (i.e. below 400 rpm), while traditional generators cannot.

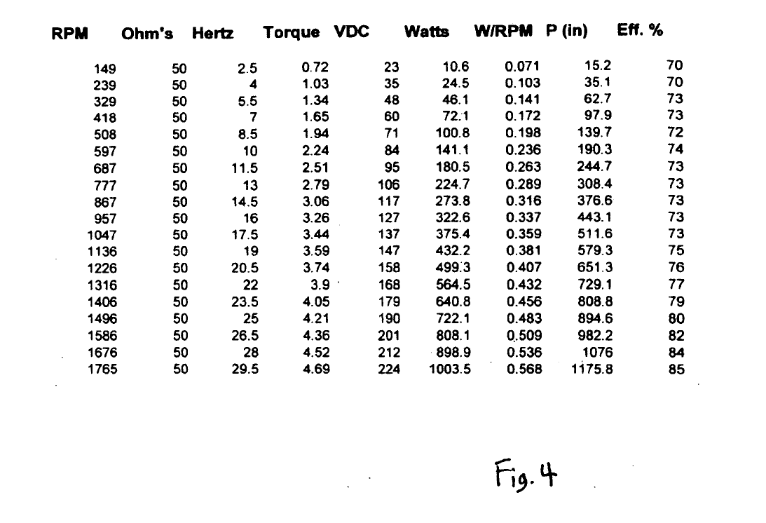

FIG. 4 shows in tabular form how efficient a generator made in accordance with the present invention can be at a wide range of rpms. The table illustrates that even when the rpm is at a mere 149, the generator is 70% efficient (i.e. in terms of converting mechanical energy to electrical energy). The generator remains efficient even as the rpms are increased to over 1700.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. An electric energy converter comprising:
a first peripheral magnetic field element having a north pole and a second peripheral magnetic field element having a south pole, the north pole of the first peripheral magnetic field element being aligned with the south pole of the second peripheral magnetic field element;
a central magnetic field element positioned between the first and second peripheral magnetic field elements, the central magnetic field element having opposite north and south poles, the central magnetic field element being oriented such that the north pole of the central magnetic field element is aligned with the north pole of the first magnetic peripheral field element and the south pole of the central magnetic field element is aligned with the south pole of the second peripheral magnetic field element;
an armature comprising a plurality of parallel pairs of linear coils positioned between the peripheral magnetic field elements with the central magnetic field element positioned between each pair of linear coils.

2. The electrical energy converter of claim 1 wherein the central magnetic field element has an elongated axis and wherein the linear coils are all positioned co-planar to the elongated axis of the central field element.

3. The electrical energy converter of claim 1 wherein the central and peripheral magnetic field elements are configured such than an area of minimal magnetic flux exists between the central magnetic field element and the first peripheral magnetic field element and between the central magnetic field element and the second peripheral magnetic field element, and wherein the linear coils are further dimensioned and configured such that a center of each of the linear coils pass through said areas of minimal magnetic flux.

4. The electrical energy converter of claim 1 wherein the first and second magnetic field elements and the central magnetic field element all comprise permanent magnets.

5. The electrical energy converter of claim 3 wherein each of the linear coils are wrapped around an iron core.

6. The electrical energy converter of claim 5 wherein the linear coils are positioned such that the iron cores are positioned to pass through the areas of minimal magnetic flux.

7. The electrical energy converter of claim 3 wherein the central magnetic field element comprises an elongated magnet having an elongated axis with the north poll and the south poll on opposite sides of the elongated axis and wherein the linear coils are all positioned co-planar to the elongated axis.

8. The electrical energy converter of claim 7 wherein each of the linear coils further comprise an iron core positioned at the center of the linear coil.

9. The electrical energy converter of claim 8 wherein the first and second peripheral magnetic field elements and the central magnetic field element all comprise permanent magnets.

10. An electro-mechanical energy converter comprising:
a housing containing a rotor and a stator;
the stator comprising a central magnet positioned between first and second peripheral magnets, the central magnet having an axis and opposite north and south polls on opposite sides of the axis, the first and second peripheral magnets having north and south polls, respectively, oriented such that the north poll of the central magnet is oriented towards and aligned with the north poll of the first peripheral magnet and the south poll of the central magnet is oriented towards and aligned with the south poll of the second peripheral magnet;
a rotor rotatably mounted to the housing comprising at least one pair of parallel windings oriented such that the central magnet is positioned between the windings and the windings are positioned between the first and second peripheral magnets, the windings being parallel to the axis of the central magnet.

11. The electro-mechanical energy converter of claim 10 wherein the central magnet and the first and second peripheral magnets are configured such that areas of minimal magnetic flux exist between the central magnet and the first peripheral magnet and between the central magnet and the second peripheral magnet, and wherein the windings are further dimensioned and configured such that a center of each of the windings intersect said areas of minimal magnetic flux.

12. The electro-mechanical energy converter of claim 11 wherein each of the windings are wrapped around a core.

13. The electro-mechanical energy converter of claim 10 wherein the central magnet comprises an elongated permanent magnet having a long axis with the north and south polls of the central magnet extending along opposite sides of the long axis.

14. The electro-mechanical energy converter of claim 13 wherein the north pole of the first peripheral magnet and the south pole of the second peripheral magnets are elongated and oriented parallel to the long axis of the central magnet.

15. The electro-mechanical energy converter of claim 14 wherein the windings comprise elongated coils oriented parallel to the central magnet.

16. The electro-mechanical energy converter of claim 15 wherein the central magnet and the first and second peripheral magnets are configured such that there are areas of minimal magnetic flux between the central magnet and the first peripheral magnet and between the central magnet and the second peripheral magnet, and wherein the windings are further dimensioned and configured such that a center of each of the windings intersect said areas of minimal magnetic flux.

17. The electro-mechanical energy converter of claim 16 wherein each of the windings are wrapped around an iron core.

18. An electro-mechanical energy converter comprising:
a housing containing a rotor and a primary stator and a secondary stator;
the primary stator comprising a central cylinder magnet positioned at a center of the rotor, said central cylinder magnet having opposite ends, opposite sides and at least a north and a south pole, said central cylinder magnet being magnetized diametrically so that the north and south poles are positioned on the opposite sides and not the opposite ends;
the secondary stator comprising first and second magnets on a periphery of the rotor, the first and second magnets being positioned 180 degrees from each other, each of the first and second magnets having a north and south pole, the first and second magnets being separated from the central cylinder magnet by a space;
the primary and secondary stators being configured such that the north pole of the primary stator is oriented towards the north pole of the first magnet and the south pole of the primary stator is oriented towards the south pole of the second magnet, and a rotor rotatably mounted in the housing, the rotor comprising at least two vertically wound parallel windings, the rotor being dimensioned and configured such that the vertically wound parallel windings are positioned in the space with the central cylinder magnet positioned between them.
